(19) United States
(12) Patent Application Publication
(10) Pub. No.: US 2010/0070778 A1
(43) Pub. Date: Mar. 18, 2010

(54) SECURE FILE ENCRYPTION

(75) Inventor: Eric Murray, Los Gatos, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: SafeNet, Inc, Belcamp, MD (US)

(21) Appl. No.: 12/448,584

(22) PCT Filed: Jan. 28, 2008
(86) PCT No.: PCT/US08/52228

§ 371 Date: Jun. 24, 2009

Related U.S. Application Data
(60) Provisional application No. 60/897,802, filed on Jan. 26, 2007.

(51) Int. Cl. G06F 21/24

(52) U.S. Cl. 713/189

(57) ABSTRACT

A technique for secure file encryption first choose a file encryption key randomly among a set of file encryption keys and encrypts a file using the chosen file encryption key based on a set of encryption rules. The file encryption key can then be encrypted via a directory master secret (DMS) key for an extra layer of security so that an intruder cannot decrypt the encrypted file even if the intruder gains access to the DMS-encrypted file encryption key. Finally, the DMS-encrypted file encryption key can be stored in a metadata associated with the file.

### BACKGROUND

Good cryptographic practice requires using different keys and initialization vectors (IVs) for different files instead of using one key or IV per file system or host. If all files share a same key, then an attacker who has broken the key can decrypt all files encrypted with that key. Since some files are of greater value than others, and may have different ownerships or access rights, this means that security of the encrypted files is determined by the least well-protected file. On the other hand, reusing IVs means that anyone who can read the ciphertext can see if two files' first N blacks are identical, which poses an information leak.

These are but a subset of the problems and issues associated with file encryption, and are intended to characterize weaknesses in the prior art by way of example. The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for secure file encryption first choose a file encryption key randomly among a set of file encryption keys and encrypts a file using the chosen file encryption key based on a set of encryption rules. The file encryption key can then be encrypted via a directory master secret (DMS) key for an extra layer of security so that an intruder cannot decrypt the encrypted file even if the intruder gains access to the DMS-encrypted file encryption key. Finally, the DMS-encrypted file encryption key can be stored in a metadata associated with the file.

The proposed system can offer, among other advantages, encryption keys that are secret even to users of the encryption keys. This and other advantages of the techniques described herein will become apparent to those skilled in the art upon a reading of the following descriptions and a study of the several figures of the drawings.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts an example of a system including a directory master secret (DMS) key database.

FIG. 2 depicts an example of a system with non-local storage of DMS keys.

FIG. 3 depicts a flowchart of an example of a method for encrypting a file encryption key and storing the encrypted key in file metadata.

FIG. 4 depicts a flowchart of an example of a method for obtaining an encrypted file encryption key from metadata of an encrypted file, decrypting the file encryption key, and using the decrypted file encryption key to decrypt the file.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

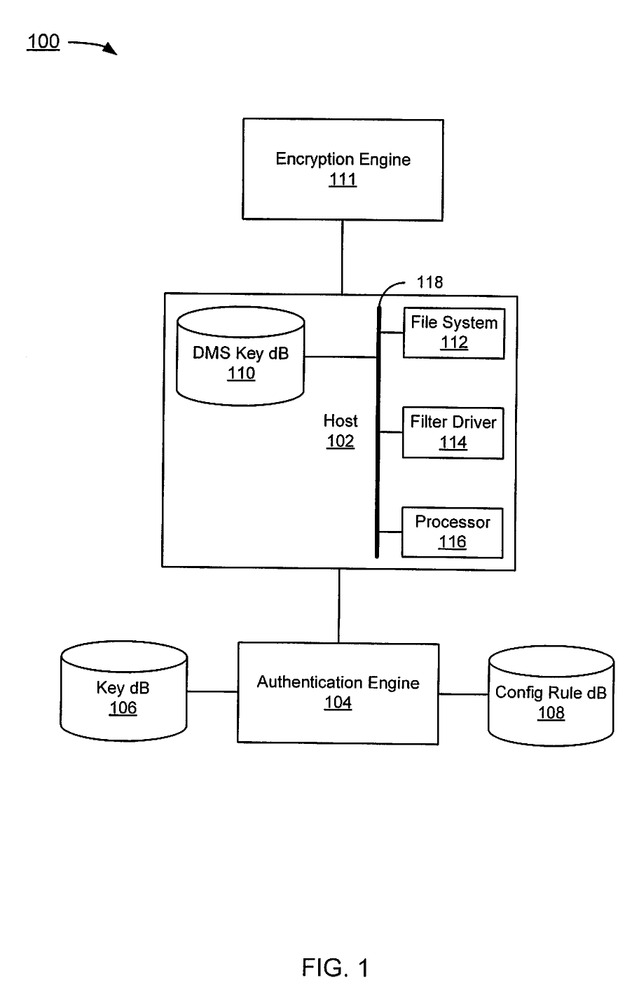

FIG. 1 depicts an example of a system 100 to support secure file encryption. The system 100 includes a host 102, an authentication engine 104, a key database 106, an encryption (configuration) rule database 108, a directory master secret (DMS) key database 110, and an encryption engine 111.

The host 102 in the example of FIG. 1 may include any known or convenient computer system. The host 102 may function as a file server or have some other functionality. In an illustrative embodiment, the host 102 includes a DMS (key) database 110, a file system 112, a filter driver 114, and a processor 116 coupled to a bus 118. The functionality of the file system 112, filter driver 114, processor 116, and bus 118 are well-known in the relevant art, so a detailed description of these components is deemed unnecessary. It may be noted that bus-less architectures may be used in alternative embodiments.

Conceptually, the filter driver 114 is inserted, as part of the operating system, between the file system 112 and a process that will use files from the file system 112. The filter driver 114 applies the encryption rules provided from the encryption rule database 108 by the authentication engine 104. The encryption rules may include, by way of example but not limitation, a rule that everything in a first directory is to be encrypted using a first key provided from the key database 106 by the authentication engine 104. (Alternatively, the first key could be generated locally or received from some place other than the key database 106.) As another example, the encryption rules may include a rule that a first user receives encrypted data (e.g., cipher text) when accessing a particular file.

In an illustrative embodiment, each file in the file system 112 should have a unique file key (and some or all of the files could have multiple unique file keys) from the key database 106. The file keys may then be encrypted in a directory master secret (DMS) key. Advantageously, having files encrypted in their own keys allows flexibility in the location of the DMS keys—they can be local for faster performance.

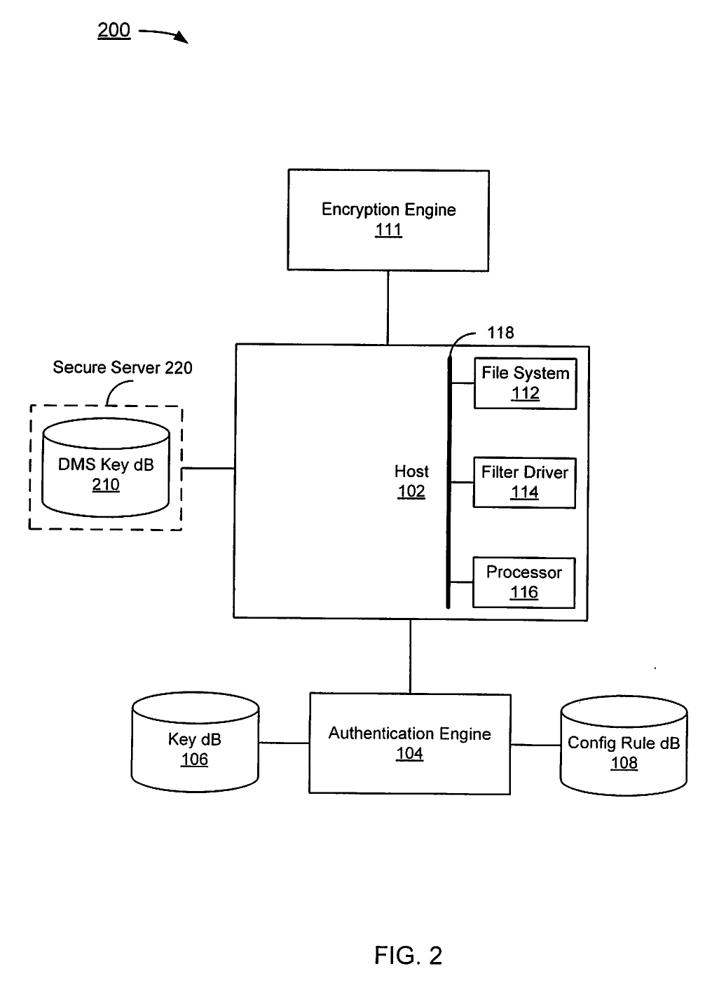

Dependent upon the embodiment, the DMS keys could reside, by way of example but not limitation, in masked software, on a secure server (e.g., a NETWORK ATTACHED ENCRYPTION™ server), or in some other convenient location. In the example of FIG. 1, the DMS keys are stored local to the host 102 in a DMS database 110. FIG. 2, on the other hand, depicts an example of a system 200 with non-local storage of DMS keys. The system 200 is quite similar to the system 100, but the DMS keys database 210 is located on a secure server 220 for additional security.

The authentication engine 104 in the example of FIG. 1 may include any known or convenient computer system. The authentication engine 104 may or may not be implemented as an appliance that is coupled to the host 102, or as some other device or computer coupled to the host 102 through, e.g., a network connection. The authentication engine 104 provides file encryption keys, directory master secret (DMS) keys, and encryption rules from the key database 106, the encryption rule database 108, and the DMS database 110, respectively, to the encryption engine 111. The term “engine,” as used herein, generally refers to any combination of software, firmware, hardware, or other component that is used to effectuate a purpose.

The authentication engine 104 may be administered by the same admin as administers the host 102. Alternatively, an admin may be responsible for administering the authentication engine 104, and a lower level administrator may be responsible for administering the host 102. The latter would be more typical in a relatively large enterprise. It may be noted that the administrator of the authentication engine 104 might be able to crack at least some of the security of the host 102 (since the admin of the authentication engine 104 has access to the keys and encryption rules provided to the host 102), but the reverse is not necessarily true.

The encryption engine 111 is coupled to the host 102. In an alternative embodiment, the file encryption engine 111 may be on the host 102. By “on the host” it is intended to mean that executable code of the encryption engine 111 is stored on or off of the host 102 in secondary memory, and at least partially loaded into primary memory of the host 102 for execution by a processor, such as the processor 116.

The encryption engine 111 may be referred to as including or sharing a computer-readable medium (e.g., memory), including executable software code stored in the computer-readable medium, and including or sharing a processor capable of executing the code on the computer-readable medium. As such, the file encryption engine 111 may be referred to as being embodied in a computer-readable medium.

In the example of FIG. 1 and FIG. 2, in operation, the authentication engine 104 provides file encryption keys, DMS keys, and encryption rules to the encryption engine 111. The encryption engine 111 randomly picks a file encryption key from the file encryption keys provided by the authentication engine 104, and encrypts a file residing in the file system of the host 102 using the file encryption key based on the encryption rules. The encryption engine 111 then encrypts the file encryption key using the DMS key and stores the encrypted file encryption key in a metadata associated with the file. When the encrypted file is later to be used, the encryption engine 111 retrieves the encrypted file encryption key from the metadata of the file, decrypts the encrypted file encryption key using the DMS key, and then decrypts the encrypted file using the decrypted file encryption key before providing the file to a user.

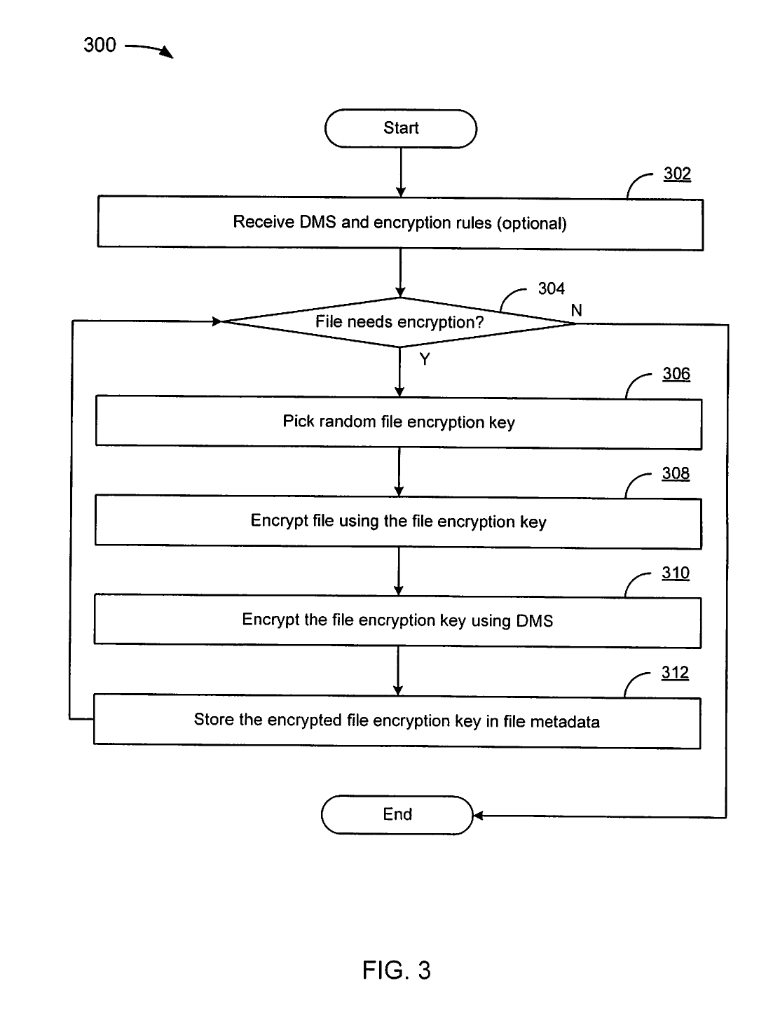

FIG. 3 depicts a flowchart 300 of an example of a method for encrypting a file encryption key and storing the encrypted key in file metadata. This method and other methods are depicted as serially arranged modules. However, modules of the methods may be reordered, or arranged for parallel execution as appropriate.

In the example of FIG. 3, the flowchart 300 starts at optional module 302 with receiving a DMS key and one or more encryption rules. The encryption rules may include user names to be given ciphertext instead of a decrypted file (e.g., plaintext). This rule is somewhat counterintuitive in that one would normally expect a rule to include names that are allowed access to the decrypted file, disallowing others. However, here some users may want access to the ciphertext for administrative purposes.

In the example of FIG. 3, the flowchart 300 continues to decision point 304 where it is determined whether a file needs encryption. If there are no files that need encryption (304-N), then the flowchart 300 simply ends. If, on the other hand, a file needs encryption (304-Y), the flowchart 300 continues to module 306 with picking a random file encryption key. Generally, the same key should not be used for lots of data. For example, if lots of data is encrypted using a single key, an attacker could use analytic techniques applied to the encrypted data to determine the key. So, good cryptographic practice is to use a key for relatively small amounts of data. Advantageously, the key is secret even to the user performing the encryption because it can be selected randomly, and it is encrypted (as described later) with a DMS key.

In the example of FIG. 3, the flowchart 300 continues to module 308 with encryption of the file based on the encryption rules. Advantageously, at module 306, a file encryption key is chosen (at least in this example) randomly for each file. So at module 308 the file is encrypted with a file encryption key that no other file on the system was encrypted with. It may be noted that there may be some cases where other files were encrypted with the same key. For example, the same random key could be generated twice. In general, so long as it is difficult to identify which files were encrypted with the same key, this is may be an acceptable security risk. (If it is not an acceptable risk, then the system simply needs to ensure that keys are never duplicated at module 306.)

In the example of FIG. 3, the flowchart 300 continues to module 310 with encrypting the file encryption key using the DMS key. Each file key is encrypted using the same DMS key. However, it is difficult for an intruder to find the DMS key used for such encryption even if multiple file keys are examined with analytical techniques.

In the example of FIG. 3, the flowchart 300 ends at module 312 with storing the encrypted file encryption key in file metadata. Thus, each file maintains an encrypted copy of its own key. Agents that know the DMS are therefore able to encrypt any file if they have access to the file's metadata.

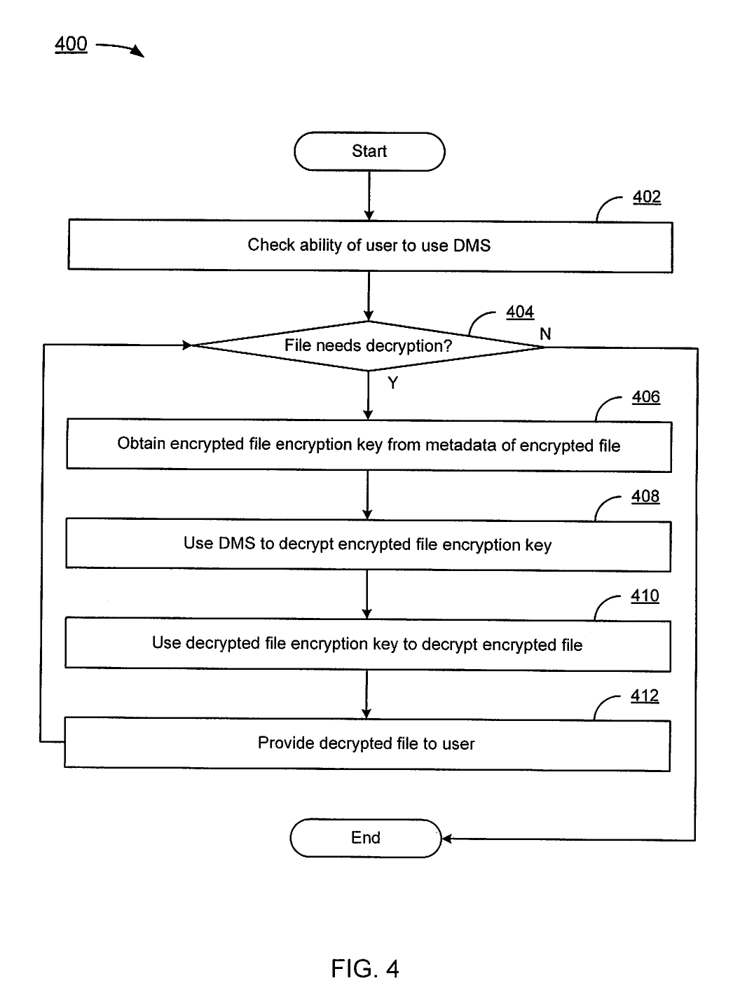

FIG. 4 depicts a flowchart 400 of an example of a method for obtaining an encrypted file encryption key from metadata of an encrypted file, decrypting the file encryption key, and using the decrypted file encryption key to decrypt the file. In the example of FIG. 4, the flowchart 400 starts at module 402 with checking the authority of a user to access the encrypted file and/or the DMS key. If a user cannot access the encrypted files or use the DMS, then the user will not be able to decrypt files associated with the DMS key. Here, by “associated with the DMS,” means that the file metadata of the associated files includes a file encryption key that is encrypted with the DMS key.

In the example of FIG. 4, the flowchart 400 continues to decision point 404 where it is determined whether a file needs decryption. If it is determined no files need decryption (404-N), then the flowchart 400 ends. If, on the other hand, it is determined that there is a file that needs to be decrypted (404-Y), then the flowchart 400 continues to module 406 where an encrypted file encryption key is obtained from the metadata of the encrypted file.

In the example of FIG. 4, the flowchart 400 continues to module 408 where DMS key is used to decrypt the encrypted file encryption key and then to module 410 where the decrypted file encryption key is used to decrypt the encrypted file. Here, he encrypted file is associated with the DMS and the user is allowed to use the DMS (402).

In the example of FIG. 4, the flowchart 400 ends at module 412 with providing the decrypted file to the user. It may be noted that this could be achieved passively (i.e., the file is decrypted and the user can access the file if desired.)

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and techniques described herein also relate to apparatus for performing the algorithms and techniques. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A system, comprising:
a host having a file stored in a file system of the host;
an authentication engine, which while in operation, provides one or more file encryption keys, one or more encryption rules, and a DMS key to an encryption engine;
said encryption engine, which while in operation:
encrypts the file using the file encryption key based on the one or more encryption rules;
encrypts the file encryption key using the DMS key.

2. The system of claim 1, further comprising:
a key database operable to manage and store the one or more file encryption keys.

3. The system of claim 1, further comprising:
a encryption rule database operable to manage and store the one or more encryption rules.

4. The system of claim 1, further comprising:
a DMS database operable to manage and store the DMS key.

5. The system of claim 1, wherein:
the file also comprises a metadata associated with the file.

6. The system of claim 5, wherein:
the encryption engine stores the encrypted file encryption key in the metadata.

7. The system of claim 1, wherein:
the encryption engine picks the file encryption keys randomly from the one or more file encryption keys.

8. A system, comprising:
an authentication engine, which while in operation, provides one or more file encryption keys, one or more encryption rules, and a DMS key to a decryption engine;
a host having an encrypted file stored in a file system of the host, wherein the file is encrypted via one of the one or more file encryption keys and the file encryption key is encrypted via the DMS key;
said decryption engine, which while in operation:
decrypts the encrypted file encryption key using the DMS key;
decrypts the encrypted file using the decrypted file encryption key based on the one or more encryption rules.

9. The system of claim 8, wherein:
the decryption engine obtains the encrypted file encryption key from metadata of the encrypted file.

10. The system of claim 8, wherein:
the decryption engine checks authority of a user to access the encrypted file and/or the DMS key before decryption.

11. The system of claim 10, wherein:
the encryption engine provides the decrypted file to the user.

12. A method, comprising:
accepting one or more encryption keys, one or more encryption rules, and a DMS key;
choosing a file encryption key from the one or more encryption keys;
encrypting a file using the file encryption key based on the one or more encryption rules;
encrypting the file encryption key using the DMS key.

13. The method of claim 12, further comprising:
managing and storing the one or more file encryption keys via a key database.

14. The method of claim 12, further comprising:
managing and storing the one or more encryption rules via a encryption rule database.

15. The method of claim 12, further comprising:
managing and storing the DMS key via a DMS database.

16. The method of claim 12, further comprising:
picking the file encryption key randomly from the one or more encryption keys.

17. The method of claim 12, further comprising:
storing the encrypted file encryption key in metadata associated with the file.

18. A method, comprising:
accepting one or more encryption keys, one or more encryption rules, and a DMS key;
accepting a file encrypted via one of the one or more file encryption keys, wherein the file encryption key is encrypted via a DMS key;
decrypting the encrypted file encryption key using the DMS key;
decrypting the encrypted file using the decrypted file encryption key based on the one or more encryption rules.

19. The method of claim 18, further comprising:
obtaining the encrypted file encryption key from metadata of the encrypted file.

20. The method of claim 18, further comprising:
checking authority of a user to access the encrypted file and/or the DMS key before decryption.

21. The method of claim 20, further comprising:
providing the decrypted file to the user.

22. A system, comprising:
means for accepting one or more encryption keys, one or more encryption rules, and a DMS key;
means for choosing a file encryption key randomly from the one or more encryption keys;
means for encrypting a file using the file encryption key based on the one or more encryption rules;
means for encrypting the file encryption key using the DMS key;
means for storing the encrypted file encryption key in a metadata associated with the file.
